(19) United States
(12) Patent Application Publication
(10) Pub. No.: US 2014/0102297 A1
(43) Pub. Date: Apr. 17, 2014

(54) METHOD FOR REMOVAL OF CO2 FROM EXHAUST GAS USING FACILITATED TRANSPORT MEMBRANES AND STEAM SWEEPING

(71) Applicant: Saudi Arabian Oil Company, Dhahran (SA)

(72) Inventors: Esam Zaki HAMAD, Dhahran (SA); Ahmed A. Bahamdan, Dhahran (SA); Feras Hamad, Dhahran (SA); Garba Oloriegbe Yahaya, Dhahran (SA); Wajdi Issam Al-sadat, Dhahran (SA)

(73) Assignee: Saudi Arabian Oil Company, Dhahran (SA)

(21) Appl. No.: 14/048,680

(22) Filed: Oct. 8, 2013

Related U.S. Application Data
(60) Provisional application No. 61/714,933, filed on Oct. 17, 2012.

(51) Int. Cl. F01N 3/00; B01D 53/22

(52) U.S. Cl. CPC F01N 3/00; B01D 53/22
USPC 95/51; 96/4

(57) ABSTRACT

The invention relates to methods for separating CO₂ from mixed gases. A stream of mixed gases passes one side of a facilitated transport membrane, while a sweep fluid, such as steam, passes the other side of the membrane, removing the CO₂. The method is especially useful in the removal of CO₂ from gases produced by internal combustion engines on mobile devices.

### RELATED APPLICATION

This application claims priority of Application Ser. No. 61/714,933 filed Oct. 17, 2012, and incorporated by reference herein.

### FIELD OF THE INVENTION

This invention relates to methods for removing CO₂ from mixed gases, such as exhaust gases produced via internal combustion engines (“ICE”) on board mobile transportation devices. The invention employs a facilitated transport membrane for removal of CO₂, and steam sweeping technology to facilitate removal of the CO₂ taken up by the membrane.

### BACKGROUND AND PRIOR ART

The control of CO₂ emissions is an issue of great concern to all, including producers of hydrocarbon or fossil fuels, and manufactures and users of devices which use these fuels. Of special concern is the production of CO₂ and its release to the environment by mobile sources, such as cars, trucks, buses, motorcycles, trains, airplanes, ships and so forth. As developing countries acquire more of such devices, and so-called developed nations acquire more, the concern with the impact of CO₂, CH₄ and other “greenhouse gases” can only grow.

Current approaches to capturing and storing CO₂ so as not to release it to the environment center around chemical absorption, using amine solutions. This approach, however, is far from acceptable as it is not environmentally benign, it is costly, and its “foot print” is relatively large. Separation and storage via the use of polymeric membranes is a possible approach to the problem which avoids those associated with the use of amine solutions. The issues with such an approach are not inconsiderable, however, as is now discussed.

High temperature environments place significant stress on polymeric membrane materials. While gas separation using polymeric membranes is well known, their use has been limited to lower temperature conditions, as a result of the degradation or inactivity of membranes at high temperatures. At high temperatures, membrane materials useful in separating CO₂ from gas mixtures (e.g., polyethylene oxide, or “PEO”), decompose, whether oxygen and/or water are present in the feed stream. (Contact with CO₂ or H₂O tends to accelerate membrane decomposition at the high temperatures involved in, e.g., operation of ICEs used with mobile devices).

While membrane materials are known which can withstand demanding environmental conditions, these are not satisfactory for separating CO₂ or other gases.

Currently, CO₂ selective membranes are chosen on the basis of solution diffusion or facilitated transport mechanisms. The former is more conventional, and suffers from the problem that, as selectivity for the gas increases, often its permeability decreases and vice versa.

Facilitated transport polymers show interesting gas separation properties, and perform better in harsh environments than do regular polymers. As defined herein, facilitated transport (“FT”) polymers as used in the invention described herein being considered for CO₂ separation are glassy, hydrophilic, thermally stable and mechanically robust, with high compressive strength. Key to their structure is the incorporation of complexing agents or carriers which exhibit strong affinity for CO₂ or other gases, on the backbone or membrane matrix of the conventional polymer molecules. These complexing agents/carriers interact selectively and specifically with e.g., CO₂ that is present in a gas mixture, and thus enhance CO₂ separation of the membranes significantly. Exemplary of the types of polymers which can be modified to FT polymers are poly(vinyl alcohol) (PVA), sodium alginate (SA), poly(acrylic acid) PAA, chitosan (CS), poly(acrylic amide) (PAAm), poly(vinyl)amine (PVAm), polyvinyl acetate, polyvinylpyrrolidone, poly(phenylene oxide) (PPO), as well as blends and copolymers thereof. The complexing agents or carriers with strong affinity for CO₂ that can be incorporated onto backbone of the above polymers include mobile carriers such as chlorides, carbonates/bicarbonates, hydroxides, ethylenediamine, diethanolamine, poly(amidoamine) dendrimers, dicyanamide, triethylamine, N,N-dimethylaminopyridine, and combinations thereof and fixed site carriers such as polyethyleneimine, polyallylamine, copolyimdes modified by various amines, and blends and copolymer thereof.

Membranes based upon these FT polymers can have dense (non-porous) or thin film composite (dense, thin layers of FT polymers, precipitated in a porous membrane) morphology. They can also be used in spiral wound or plate and frame formations, e.g., and the membranes may be in the form of bundled configurations of tubes and/or hollow fibers. The resulting membranes are used in methodologies to remove CO₂ from gas mixtures.

U.S. Pat. Nos. 8,177,885; 8,025,715; and 7,694,020 all share common disclosure. These patents address separation of CO₂ from gaseous mixtures. A sweep gas, defined as “air, oxygen enriched air or oxygen” is used, rather than steam. Part of the CO₂ is separated by crossing a membrane to a retentate side, while another part is removed in a capture step.

The membranes employed in these patents are membranes which employ solution diffusion mechanisms, rather than facilitated transport.

U.S. Pat. No. 6,767,527 to Asen, et al. discloses the use of hot steam, or mixes of steam and CO₂, as sweep gases to remove O₂ which crosses a membrane. The O₂ is removed from a CO₂ containing gas, thus leaving a product with a high CO₂ concentration, in contrast to the present invention.

U.S. Pat. No. 5,525,143 to Morgan, et al. teaches the use of hollow membrane technology together with sweep gases, in order to remove water from gases. Again, membranes which operate via solution diffusion mechanisms are used. One would not use water vapor (steam), as a sweep gas, to remove water vapor.

U.S. Pat. No. 4,761,164 to Pez, et al. teaches a membrane loaded with immobilized molten material. The material can undergo reversible reactions to remove CO₂ from N₂. Steam sweeping and ICEs are not disclosed.

Published U.S. Patent Application 2011/0239700 teaches cooling CO₂ containing mixtures, prior to passage across a transport membrane. Steam and water vapor are not described as sweep gases, nor are ICEs.

The references discussed supra, all of which are incorporated by reference, are not seen to teach or to suggest the invention claimed in this application.

### SUMMARY OF THE INVENTION

The invention relates to methods for separating CO₂ from mixed gases, such as exhaust gas produced by an internal combustion engine which uses fossil fuels, on a mobile source. The exhaust gas passes one side of a membrane (referred to as the “feed” or “retentate” side) at appropriate temperature; pressure and flow rate conditions, such that CO₂ can pass, selectively through the membrane. Conditions to facilitate this (the chemical potential difference) may be created via various means, including creating a vacuum on the other side of the membrane (the permeate side), by increasing pressure on the exhaust gas on the feed, or retentate side, or via sweeping the permeate with a gas, such as steam. See, e.g., U.S. Patent Publication No. 2008/0011161 to Finkenrath et al. incorporated by reference, showing steam sweep technology. Steam sweeping is preferred in the invention, although any single method, or combination thereof, may be used.

### BRIEF DESCRIPTION OF THE DRAWINGS

FIG. 1 shows an embodiment of the invention using steam sweeping and polymers as described herein.

FIG. 2 shows the results of a simulation—on wet basis—carried out using the invention, for a fixed feed pressure (1.5 atm) and under different permeate pressures as depicted by the ratio Pf/Pp (described herein).

FIG. 3 shows the results of the simulation, after water has been knocked down from the permeate stream, under varying pressure ratios and a fixed feed pressure (1.5 atm).

FIG. 4 depicts results of simulation to determine the appropriate area of membrane needed to secure desired amounts of separation.

FIG. 5 presents results of a simulation on dry basis—i.e., after water has been knocked down—carried out under different steam sweep flow ratios, with respect to the dry product and a fixed feed pressure (1.5 atm) and permeate pressure (1.0 atm.).

FIG. 6 shows the result of the simulation to determine the appropriate membrane area needed to secure the desired separation under steam sweep conditions.

### DETAILED DESCRIPTION OF PREFERRED EMBODIMENTS

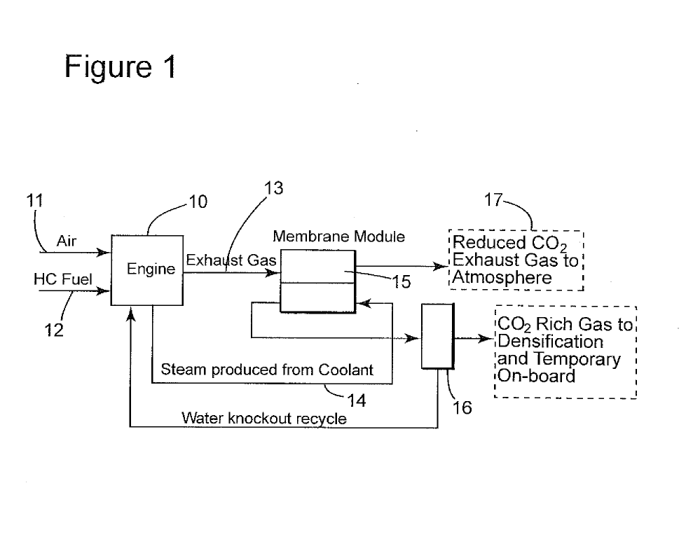

Referring now to FIG. 1, an embodiment of the invention is shown.

An engine, such as an internal combustion engine “10” is provided with both an air stream containing oxygen “11,” and a feed stream of a hydrocarbon fuel “12.” In operation, the engine produces exhaust gas “13” (which is cooled down to a suitable temperature for proper operation of the membrane module.) Such a practice is standard in the art and also used to produce steam “14.” Steam production can be achieved by tapping into the heat available in the hot exhaust gas heat exchanger and/or by tapping into the heat available in the hot coolant fluid of the engine, in each case via use of a heat exchanger. The exhaust gas is channeled to one side of an FT membrane “15,” which selectively removes CO₂ therefrom, while the steam produced is directed to the other side of the membrane, to remove the permeated gases. The steam and permeated gases stream leaving the membrane are directed to the knock down stage (16) where steam—water gas—is condensed and precipitated down by virtue of heat exchange, and is directed back to the engine (10) for steam production while the resultant CO₂-rich stream is directed to next stage for densification and storage. The CO₂ lean exhaust gas then escapes to the atmosphere “17.” Separation of the CO₂, or other gas of interest, occurs when the exhaust gas is passed on one side of the membrane (the so-called “feed” or retentate side), at appropriate conditions of temperature, pressure and flow rate. The CO₂ or other gas permeates the membrane and passes to the other side (the so-called “permeate side”). Any required driving force necessary to facilitate this can be created as a result of, creating a vacuum on the permeate side, increasing pressure on the gas on the feed or retentate side, and/or, preferably, via sweeping the permeate with a gas, such as steam, at constant pressure.

Note that in operation, the exhaust gas and steam travel in opposite directions; however, the CO₂ enriched steam then moves to an appropriate point for further removal of the CO₂ or other action.

While not wishing to be bound by any theory, performance for separation of any two gases, e.g., CO₂ and N₂, is governed by (i) the permeability coefficient, or “P_{A},” and the selectivity or separation factor, or α_{A/B}. The former is the product of gas flux and the thickness of the membrane divided by partial pressure difference across the membrane. The latter results from the ratios of gas permeability (“P_{A}/P_{B}”), where P_{A} is the permeability of the more permeable gas, and P_{B} that of the lesser. It is desirable to have both high permeability and selectivity, because a higher permeability decreases the size of membrane necessary to treat a given amount of gas, while higher selectivity results in a more highly purified product.

Operation of the invention will be seen in the examples which follow.

### EXAMPLES

The following examples detail a simulation of a facilitated transport membrane in combination with steam sweeping, for removing CO₂ from a mixed gas exhaust feed.

The exhaust gas composition was CO₂ (˜(13%), N₂ (˜74%), and H₂O (˜13%). This is representative of exhaust gas produced by combustion engines using hydrocarbon fuels.

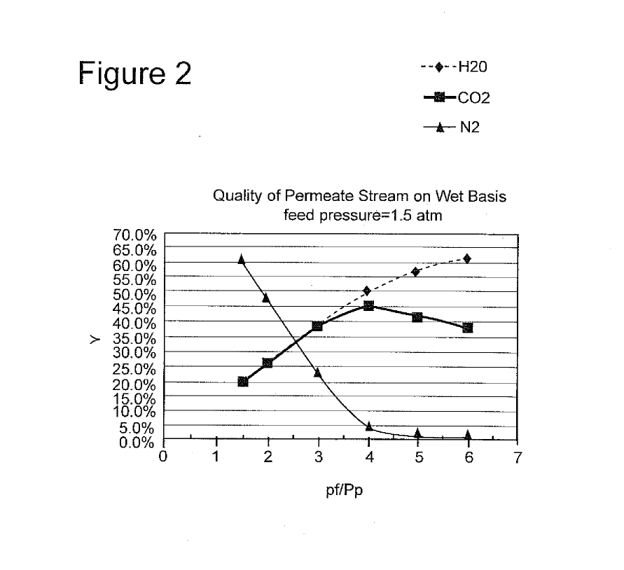

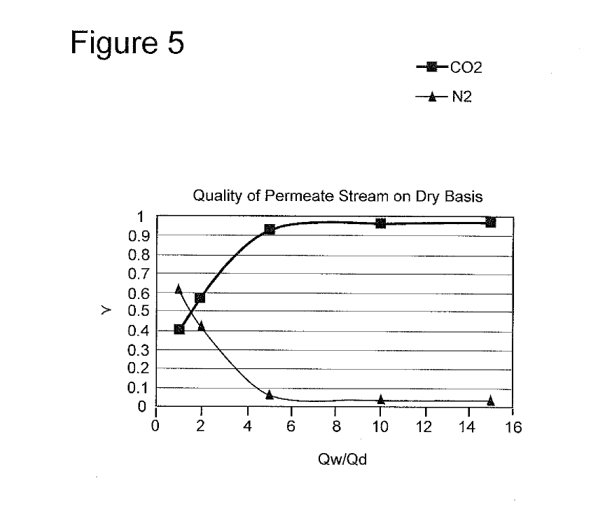

The simulation was set up for 30% recovery of CO₂ from a mixed gas, with a composition as described supra, and an exhaust gas flow rate of 28.9 gmol/min. Feed and permeate pressures of 1.5 atm and 1.0 atm, respectively were used, and the results are shown in FIG. 5, where steam was used for the sweeping step. FIGS. 2-4, in contrast, present results with no sweep conditions and with different permeate pressures but a fixed feed pressure (1.5 atm).

The theoretical membrane of the simulation had a CO₂ permeability of 4000 Barrer (1 Barrer=10-10 cm³ .(STP).cm.cm-2s-1 cm Hg-1), a CO2/N2 selectivity of about 400, and water permeability of 15000 Barrer. Two coating thicknesses, i.e., 10.0 um and 1.0 um were tested.

Criteria evaluated included the effect of feed/permeate pressure ration (Pf/Pp) and, as noted, the coating thickness.

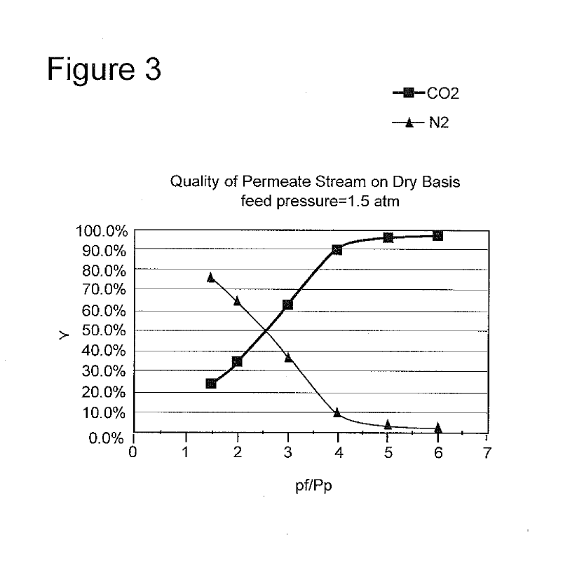

FIG. 3 shows that high purity CO2 (greater than 90%) can be obtained at a Pf/Pp ratio of 4 or greater. This experiment, however, did not use steam sweeping on the permeate side.

FIGS. 2 and 3 shows the very high permeability of water and CO2 mimics the effect of using sweep steam on the permeate side.

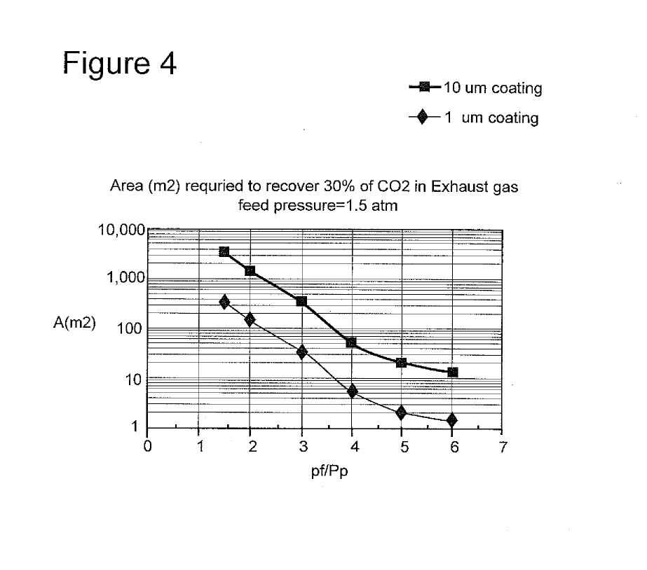

FIG. 4 shows the area, in m², needed to recover 30% of CO₂ from exhaust gas, for the two different coating thicknesses discussed supra. The figure shows that there was a sharp reduction in the required membrane area as the ratio increases, and the membrane thickness decreases.

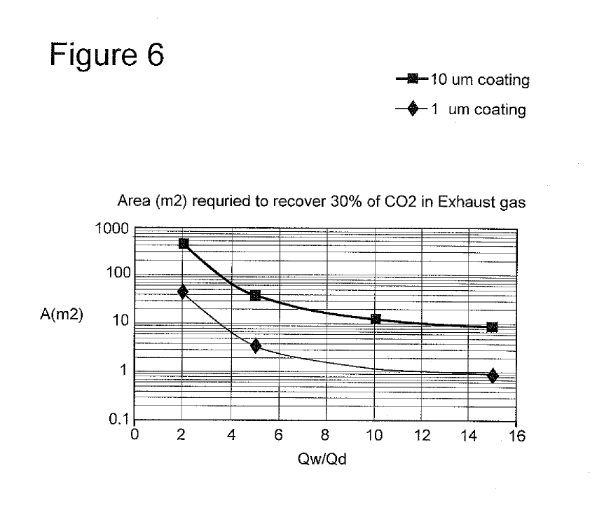

In follow-up experiments, a simulation was carried out testing a steam sweep flow rate/gas permeate flow rate ratio on separating CO₂ from the mixed gas described supra. The results are shown in FIGS. 5 and 6, with the ratio plotted as the X-axis (Qw/Qd). The exhaust gas flow rate, and the feed and permeate pressures were fixed at 1.5 and 1.0 atm.

In total, the results of the simulation shown that the theoretical, highly permeable facilitated transport membrane, when employed in the steam sweep methodology discussed herein, resulted in high CO₂ concentration (ranging up to 97% pure CO₂ FIG. 5 when the sweep steam flow ratio with respect to the dry permeate is set at 4.5 or higher.

FIG. 6 shows the area, in m², needed to recover 30% of CO₂ from exhaust gas, for the two different coating thicknesses discussed. The figure shows that there was a sharp reduction in the required membrane area as the sweep steam ratio increases, and the membrane thickness decreases.

FIGS. 4 and 6 shows that high permeability membranes are necessary in this methodology, as less membrane area was required for low membrane thickness and high permeability of the membrane.

The foregoing experiments set forth aspects of the invention, which is, inter alia, a method for removing a gas, CO₂ in particular, from a mixed gas stream, using a facilitated transport membrane in combination with pressure driven and steam sweep technologies. In practice, the mixed gas stream, such as exhaust gas from an internal combustion engine, follows a path along a first side of a facilitated transport membrane, where the membrane is specifically permeable to a specific gas, such as CO₂. For CO₂, the “FT” membrane preferably has a permeability for CO₂ of at least 1000 barrers.

A sweep fluid, preferably steam, is provided via e.g., action of a cooling system on the source of the mixed gas, such as the internal combustion engine. The steam, be it from this configuration or another, is directed along the side opposite the side on which the mixer gas stream passes, and in the opposite direction. CO₂ or some other gas moves into the sweep liquid and is carried away to, e.g., a temporary storage unit for further processing.

Different conditions of pressure, membrane thickness, gas flow, and other factors may be employed with the invention remaining operative, as the figures show.

Other features of the invention will be clear to the skilled artisan and need not be reiterated here.

The terms and expression which have been employed are used as terms of description and not of limitation, and there is no intention in the use of such terms and expression of excluding any equivalents of the features shown and described or portions thereof, it being recognized that various modifications are possible within the scope of the invention.

We claim:

1. A method for selectively removing carbon dioxide (CO₂) from a mixed gas, comprising;
(i) contacting said mixed gas to a first side of a facilitated transport (FT) membrane which has affinity for CO₂;
(ii) directing a sweep fluid to remove permeating gases from a second side of said FT membrane, or
(iii) permeating gases from second side of said FT membrane under pressure difference between the feed and the permeate sides, to selectively remove said CO₂.

2. The method of claim 1, wherein said mixed gas is an exhaust gas produced by an internal combustion engine on a mobile device.

3. The method of claim 2, wherein said mobile device is an automobile, a truck, a bus, a motorcycle, a train, an airplane, or a ship.

4. The method of claim 1, wherein said FT membrane has higher selectivity for CO₂ as compared to N₂.

5. The method of claim 1, wherein said membrane has dense homogeneous morphology.

6. The method of claim 1, wherein said membrane has thin film composite morphology.

7. The method of claim 1, further comprising storing said CO₂.

8. The method of claim 1, further comprising knockdown of water from the sweep and/or permeate gas stream mixture.

9. A carbon dioxide separation system comprising:
(i) an internal combustion engine;
(ii) a membrane module comprising a facilitated transfer membrane selectively permeable to CO₂;
(iii) a cooling means which contains a coolant and adapted to cool said internal combustion engine, wherein (i), (ii) and (iii) are positioned to provide;
(iv) a first flow path for directing exhaust gas produced by said internal combustion engine along a first side of said membrane module;
(v) a second flow path for directing steam, produced by action of cooling exhaust gas and/or said internal combustion engine coolant, along a second side of said membrane module opposite said first side,
(vi) a housing means for containing (i) through (v).

10. The carbon dioxide separation system of claim 9, further comprising a storage means for said separated CO₂.
